(19) United States
(12) Patent Application Publication
(10) Pub. No.: US 2006/0292997 A1
(43) Pub. Date: Dec. 28, 2006

(54) Tool handle having radio

(76) Inventor: Hsiu Chu Yang, Dali City (TW)

Correspondence Address: CHARLES E. BAXLEY, ESQ., 90 JOHN STREET, THIRD FLOOR, NEW YORK, NY, 10038, US

(21) Appl. No.: 11/169,980

(22) Filed: Jun. 28, 2005

(51) Int. Cl. H04B 1/38; H04M 1/00

(52) U.S. Cl. 455/90.3; 455/575.1

(57) ABSTRACT

A tool includes a handle having a chamber for receiving a radio facility and for communicating with radio stations while using or operating the handle. The radio facility includes a radio device having a circuit board disposed within a housing and having a number of electric elements and a volume adjusting knob and one or more buttons and a speaker coupled to the electric elements. One or more batteries may be used to energize the electric elements. An antenna may be electrically coupled to the circuit board, and may be coupled to a driving tool member, for facilitating signal receiving function to the radio device. The housing includes a cover having one or more spring blades for actuating the buttons.

### BACKGROUND OF THE INVENTION

1. Field of the Invention

The present invention relates to a tool handle, and more particularly to a tool handle having a radio engaged therein, for enjoying radio programs or music while working or while using the tool handle.

2. Description of the Prior Art

Typical tools, such as screw drivers, wrenches, knives, hammers, etc., comprise a handle for being grasped or held by the users, and a tool member for working onto objects or fasteners, or the like. Normally, the tool handles includes a chamber formed therein for receiving spare tool bits or tool members therein, for allowing the tool bits or tool members to be changed with each other.

Normally, when the workers or the users are going to enjoy the radio programs or music while working or while using the tools, the workers or the users have to prepare a radio equipment or the like. However, when the tools are carried and used outdoors, it will be inconvenient to enjoy the radio programs or music while working or while using the tools.

U.S. Pat. No. 5,531,365 to Donnelly discloses one of the typical belt clip for securing a device such as a personal communication device, e.g., a paper or radio, to one's belt or clothing. The belt clip may include a tool having tool elements such as a screw driver, knife, bottle cap opener, file, letter opener, cork screw, scissors, etc., for directly securing to the personal communication device.

However, when it is required to use or operate the tools, the tools have to be removed or disengaged from the personal communication device before working, and thus may not simultaneously enjoy the personal communication device while using or operating the tools.

The present invention has arisen to mitigate and/or obviate the afore-described disadvantages of the conventional tool handles.

### SUMMARY OF THE INVENTION

The primary objective of the present invention is to provide a tool handle including a radio engaged therein, for allowing the users to enjoy the radio programs or music while working or while using the tool handle.

In accordance with one aspect of the invention, there is provided a tool comprising a handle including a chamber formed therein, and a radio facility received in the chamber of the handle, for communicating with radio stations to enjoy music while using the handle simultaneously.

The radio facility includes a housing, and includes a radio device having a circuit board disposed within the housing and having a number of electric elements disposed thereon, and a volume adjusting knob and at least one button coupled to the electric elements of the circuit board, and at least one battery disposed within the housing for energizing the electric elements of the circuit board, and a speaker disposed in the housing and coupled to the electric elements of the circuit board, for generating sounds or music.

The circuit board includes an antenna electrically coupled thereto, for facilitating signal receiving function to the radio device. The handle includes a driving tool member attached thereto, the antenna may be directly or indirectly electrically coupled to the driving tool member for facilitating the signal receiving function. The radio device includes a conductor member coupled between the antenna and the driving tool member.

The handle includes at least one projection extended into the chamber thereof, the housing includes at least one perforation formed therein, for receiving the projection of the handle, and for anchoring the housing to the handle. The housing includes a cover attached thereto, and having at least one spring blade formed therein and aligned with the button of the circuit board, for actuating or depressing the button when the spring blade of the cover is depressed.

The cover includes a leg extended from the spring blade, for engaging with the button of the circuit board. The cover includes a peripheral slot formed therein, for forming the spring blade therein. The cover includes a notch formed therein and defined by a base panel which includes the spring blade provided therein.

The cover includes a cap pivotally attached to the cover with a pivot axle, to allow the cap to be rotated relative to the cover, and to selectively enclose the notch of the cover, the cap includes a latch provided thereon for engaging with the cover and for selectively latching and locking the cap to the cover; and includes a number of apertures formed therein.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tool in accordance with the present invention;

FIG. 2 is a partial exploded view of the tool;

FIG. 3 is a partial cross sectional view of the tool, taken along lines 3-3 of FIG. 1;

FIG. 4 is another partial exploded view of the tool;

FIGS. 5, 6 are enlarged partial perspective view illustrating a cover of the tool;

FIGS. 7, 8 are enlarged partial cross sectional views of the tool;

FIGS. 9, 10, 11, 12, 13 are partial perspective views illustrating the operation of the tool;

FIG. 14 is a partial cross sectional view similar to FIG. 3, illustrating the other arrangement of the tool; and

FIG. 15 is a further partial cross sectional view similar to FIGS. 3 and 14, illustrating the further arrangement of the tool.

### DETAILED DESCRIPTION OF THE PREFERRED EMBODIMENT

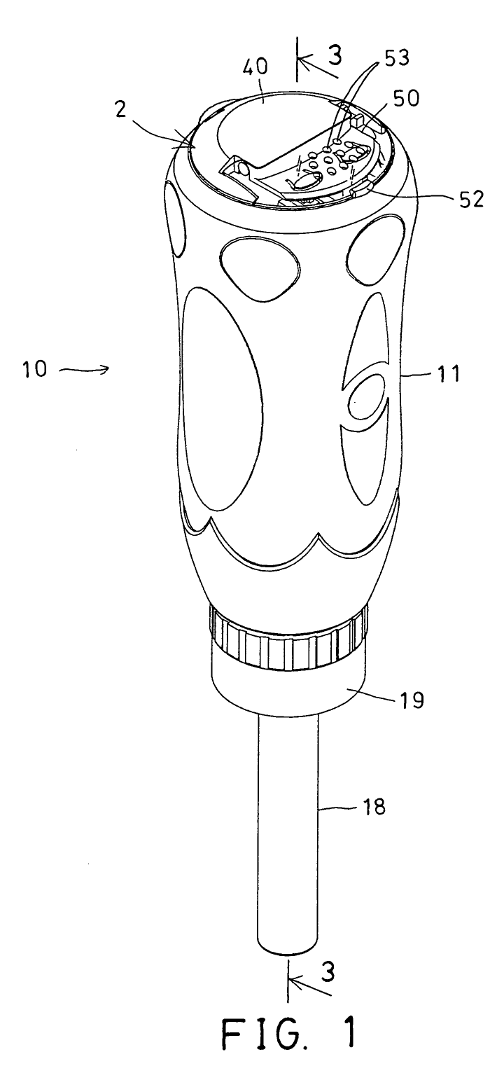

Referring to the drawings, and initially to FIGS. 1-3, a tool 10 in accordance with the present invention comprises a tool handle 11 including a chamber 12 formed therein for receiving or attaching a radio facility 2 therein. It is preferable that the tool handle 11 includes a tubular body 14 made of harder plastic or synthetic materials, and a number of portions or areas 13 made of softer rubber or resilient materials, for being comfortably grasped by the users. The tool handle 11 further includes one or more soft or resilient pegs or projections 16 extended into the chamber 12 thereof for anchoring or securing the radio facility 2 to the tool handle 11, for example.

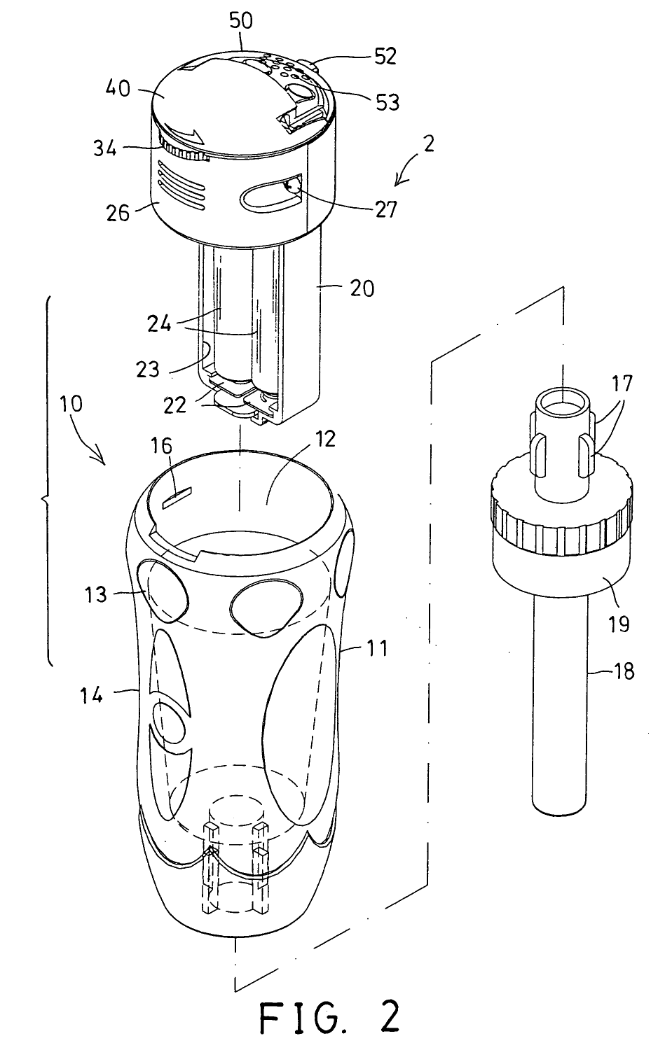

A driving tool member 18 may be attached to one end, such as the front portion of the tool handle 11 by nibs 17 (FIG. 2) or the like, for allowing the driving tool member 18 to be rotated or driven by the tool handle 11, in order to rotate or drive various tool elements, tool extensions, or fasteners, or the like. The driving tool member 18 may include a conventional ratchet mechanism 19 attached thereto. However, the driving tool member 18 and the ratchet mechanism 19 are conventional, and will not be described in further details.

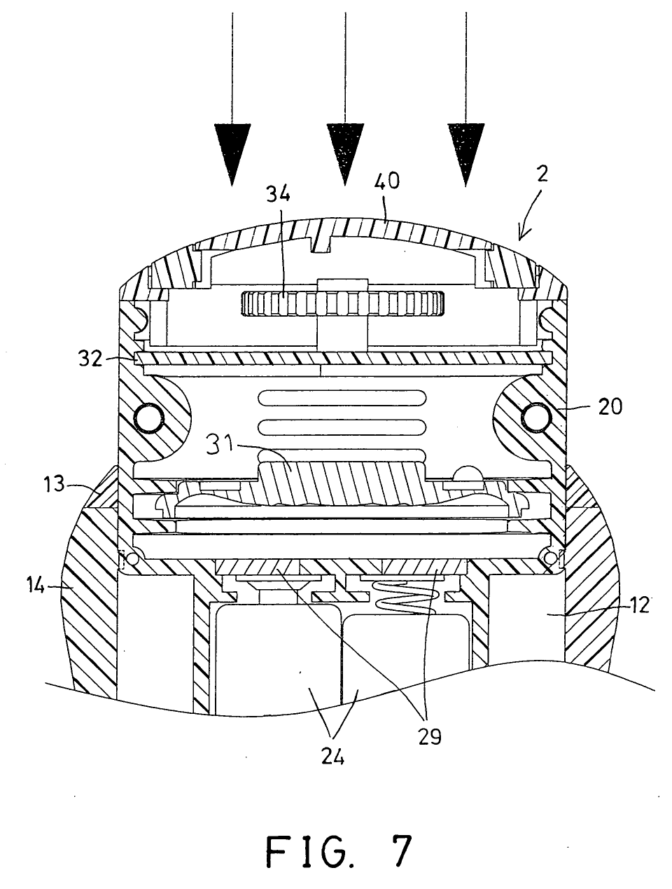

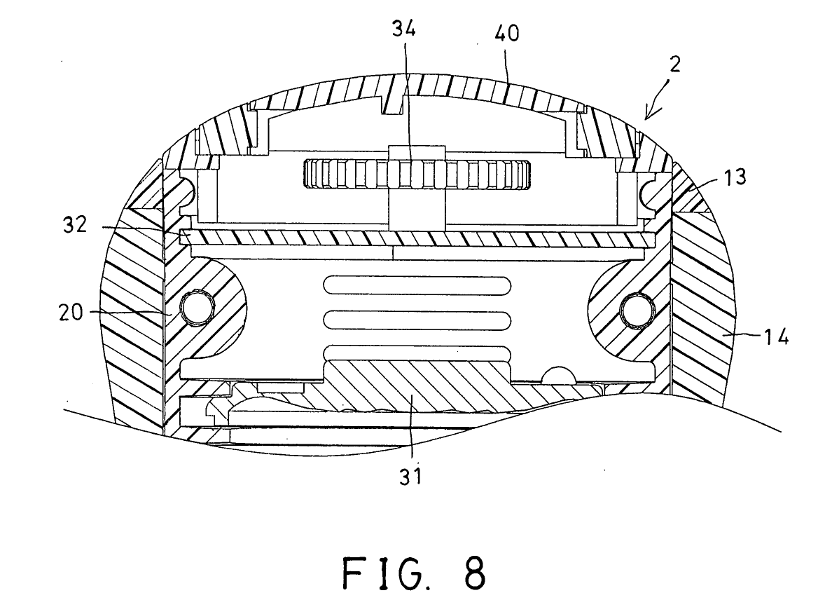

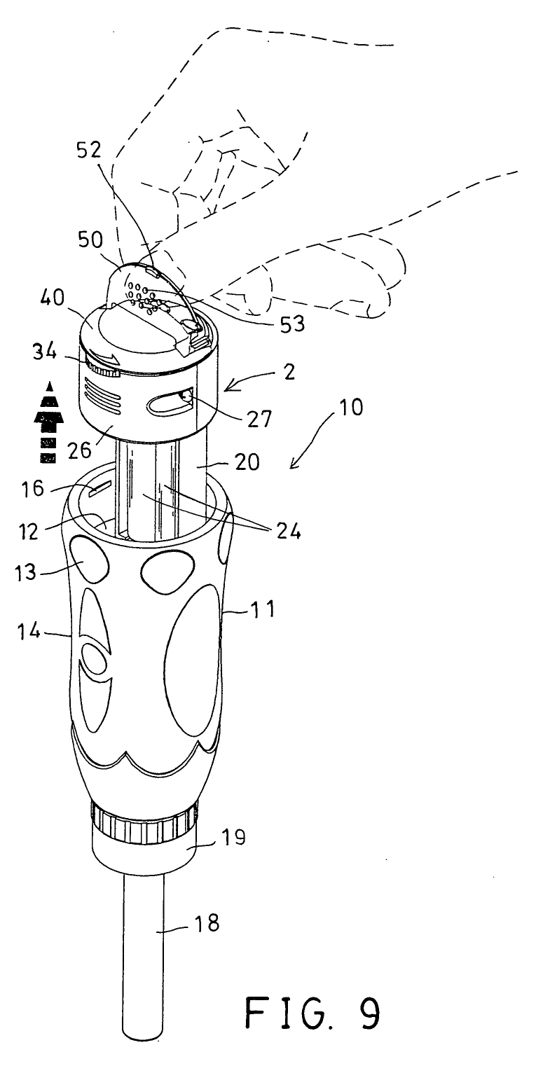

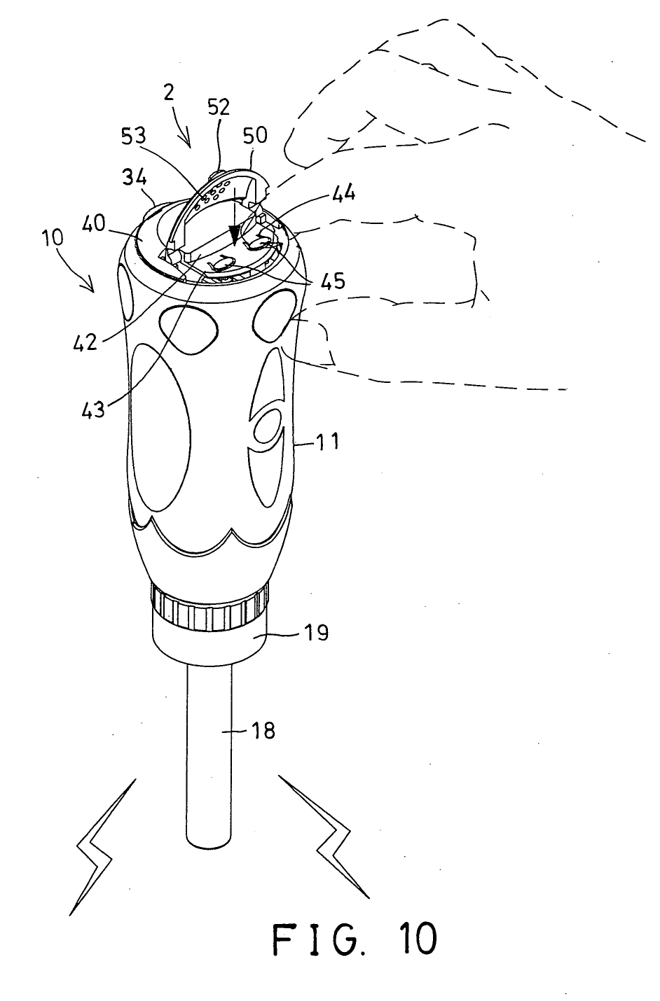

As shown in FIGS. 2-8, the radio facility 2 includes a housing 20 having one or more perforations 21 formed therein, for receiving the pegs or projections 16 of the tool handle 11, and for anchoring or securing the housing 20 of the radio facility 2 to the tool handle 11, and for allowing the housing 20 to be disengaged from the tool handle 11 (FIG. 9). The housing 20 may include a partition 22 provided in the middle portion thereof, for forming a lower chamber 23 therein, to receive one or more batteries 24 therein, and an upper chamber 25 for receiving the radio device 30 therein. A fence 26 may be secured to the upper portion of the housing 20 with such as fasteners 27, to enclose or to form the upper chamber 25 of the housing 20.

A conductor member 28 may be attached to the bottom of the housing 20, and electrically coupled to the case electrode of one of the batteries 24 and the center electrode of the other battery 24, for electrically coupling the two batteries 24 together in series. Two further conductor elements 29 may be attached to the housing 20, such as attached to the partition 22 of the housing 20, and electrically coupled to the case electrode and the center electrode of the batteries 24 respectively, and then electrically coupled to the radio device 30 via such as electric wires or cables (not shown), for energizing the radio device 30.

The radio device 30 includes a speaker 31 disposed within the upper chamber 25 of the housing 20, and includes a circuit board 32 also disposed within the upper chamber 25 of the housing 20 and having various electric parts or elements 33 disposed thereon, and a volume adjusting knob 34 and one or more channel selecting or depressing buttons 35 coupled to the electric parts or elements 33 of the circuit board 32. The speaker 31 is also coupled to the electric parts or elements 33 of the circuit board 32, for generating sounds or music.

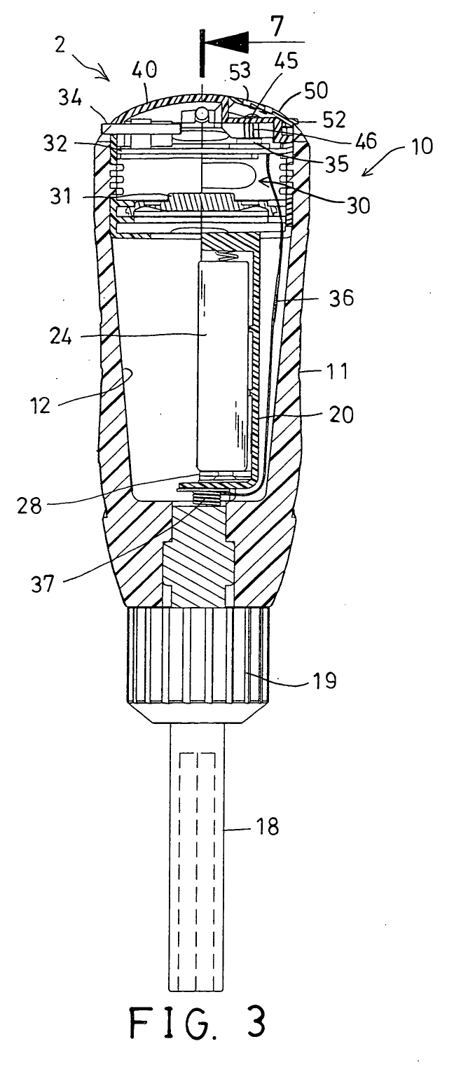

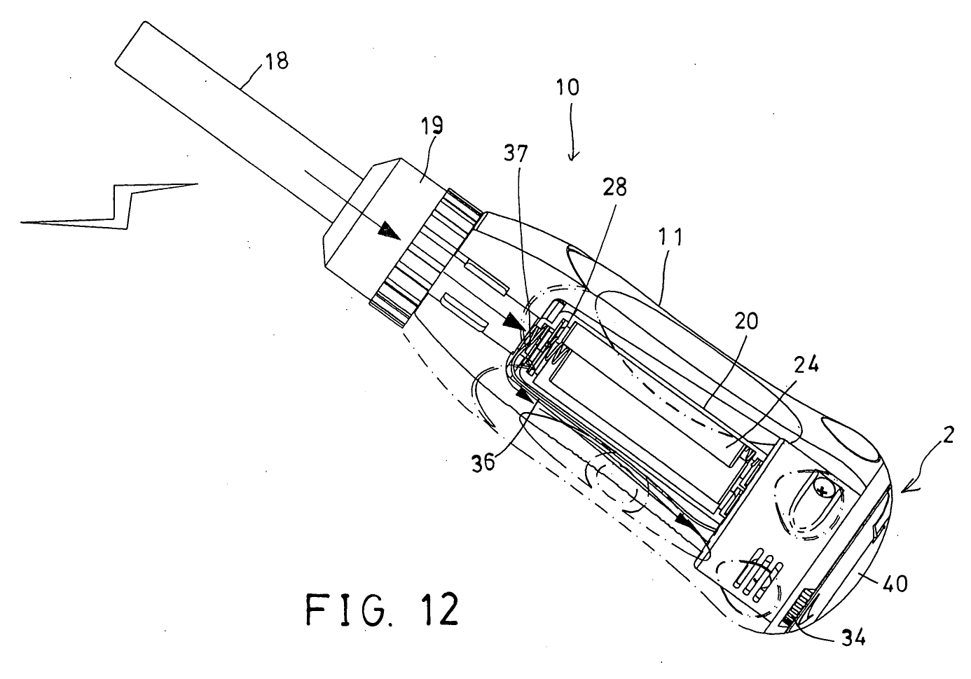

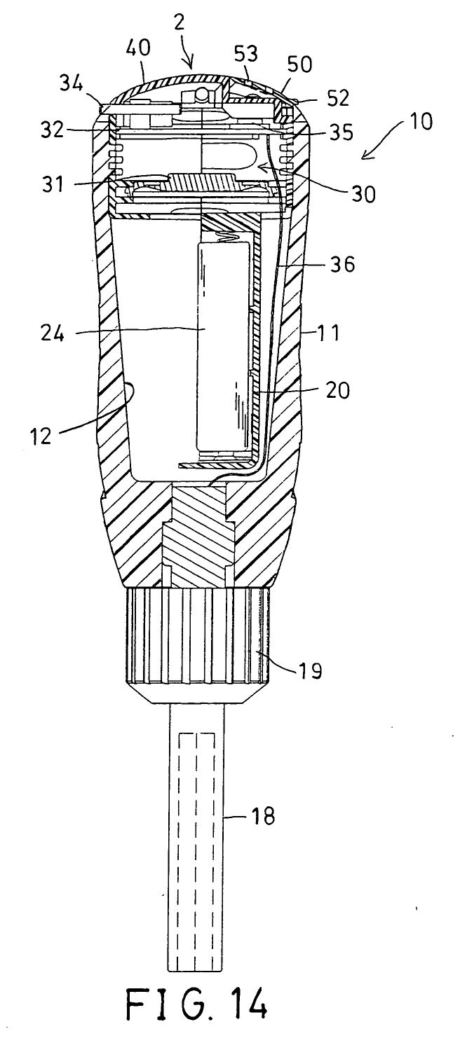

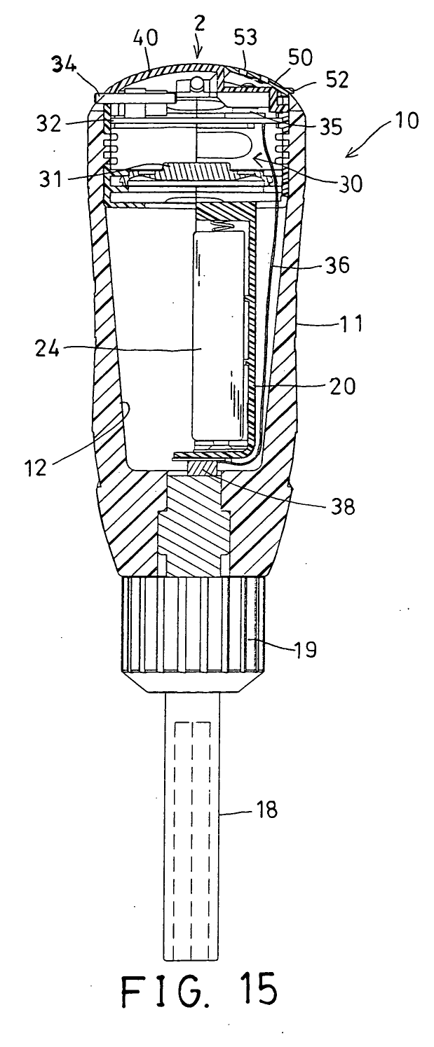

An antenna 36 may further be provided and coupled to a conductor member 37 which may be electrically coupled to the driving tool member 18 (FIGS. 3, 12), for facilitating the signal receiving function of the antenna 36 and of the radio device 30. Alternatively, the antenna 36 may also be directly coupled to the driving tool member 18 as shown in FIG. 14, or indirectly coupled to the driving tool member 18 via another conductor element 38 (FIG. 15), for allowing the antenna 36 to suitably send or receive the signals to and from the radio stations, for example. The circuit board 32 may further include a processor device or unit or a control device 39 disposed thereon, for conducting the signals receiving and/or sending operation, and for controlling or operating the radio device 30 of the radio facility 2.

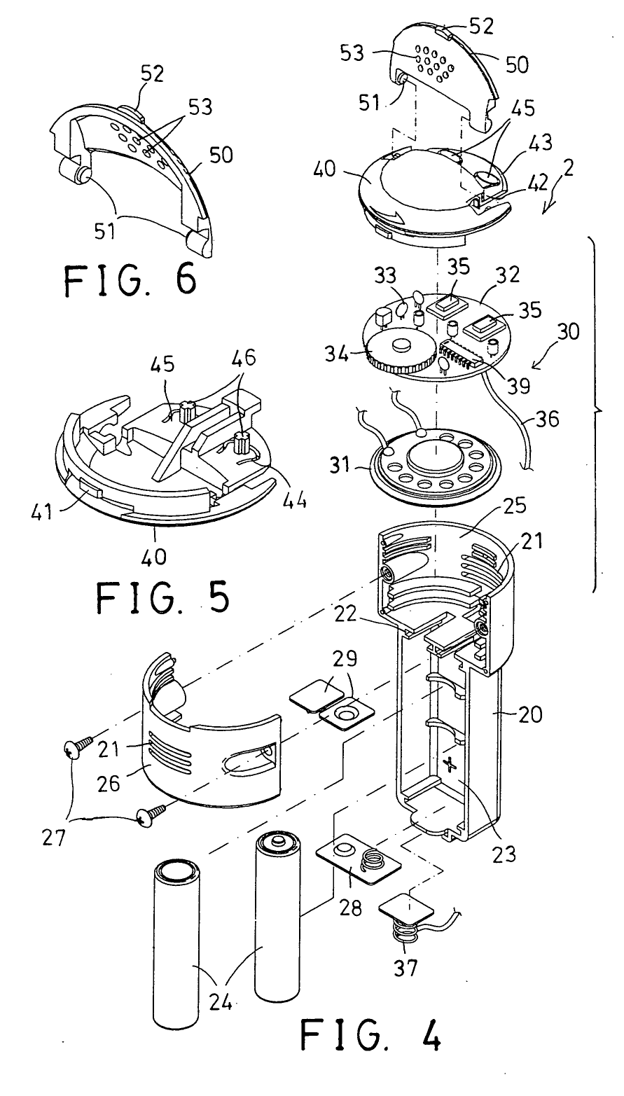

As shown in FIGS. 4-8, a cover 40 may be attached on top of the housing 20, with such as catches or latches 41, to allow the cover 40 to be openly attached or secured to the housing 20. The cover 40 includes a cut off portion or a notch 42 formed therein and defined by a base panel 43 which includes one or more peripheral slots 44 formed therein (FIG. 5), for forming or defining one or more spring blades 45 therein. The spring blades 45 are aligned with the depressing buttons 35 of the circuit board 32 respectively, and each includes a leg 46 extended therefrom, for contacting or engaging with the depressing buttons 35 of the circuit board 32 respectively.

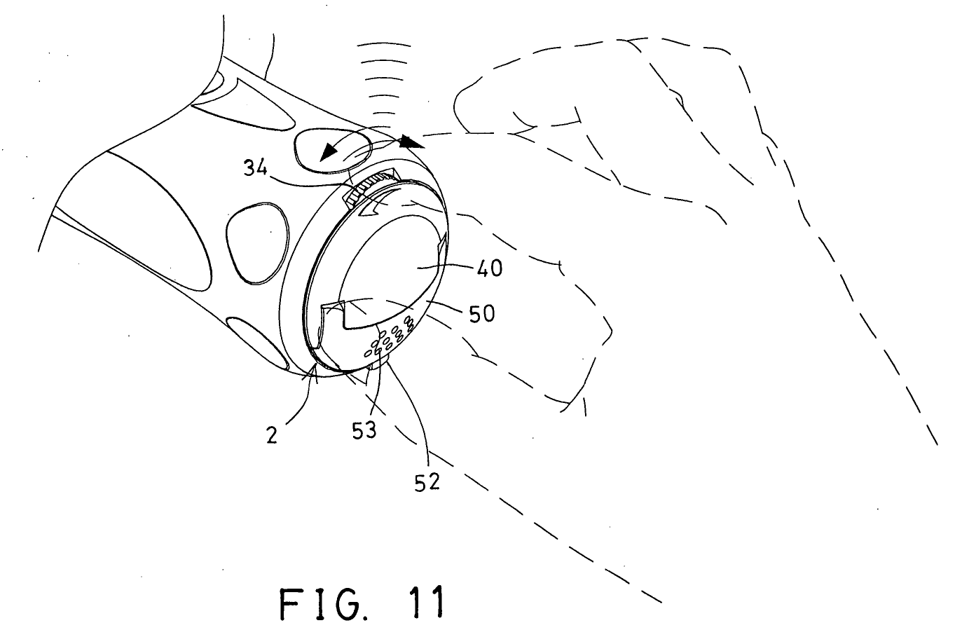

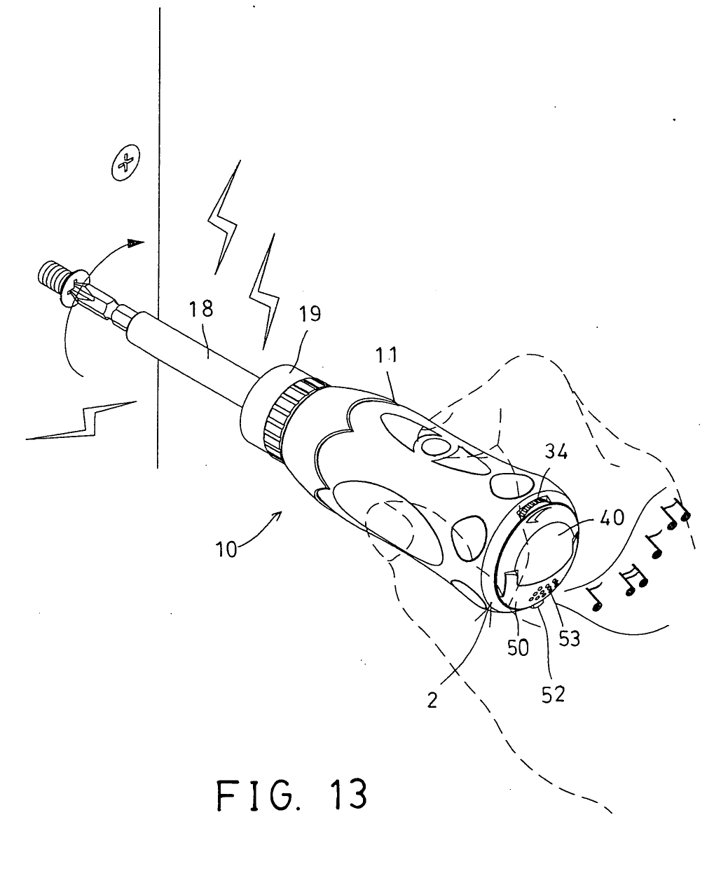

In operation, as shown in FIGS. 3 and 10, the spring blades 45 of the cover 40 may be depressed or actuated by the users, in order to force or to actuate the legs 46 to depress or to operate the depressing buttons 35 of the circuit board 32 respectively, for channel selecting purposes, or for changing or switching to the required channels by the users. The users may use the volume adjusting knob 34 to adjust the volume of the sound or music (FIG. 11). As shown in FIG. 13, the users may thus work with the tool 10 in accordance with the present invention, and enjoy the music simultaneously while working.

As shown in FIGS. 1, 2, 4, 6 and 9-11, a cap 50 may further be provided and pivotally attached or secured to the cover 40 with a pivot axle 51, to allow the cap 50 to be rotated relative to the cover 40 (FIGS. 9-10), and to selectively enclose the notch 42 of the cover 40 (FIGS. 1, 2, 11 and 13). The cap 50 includes a latch 52 formed or provided thereon for engaging with the cover 40 or the tool handle 11, for selectively latching or locking the cap 50 to the cover 40 or to the tool handle 11; and includes a number of apertures 53 formed therein, for allowing the sound generated by the speaker 31 to be clearly heard by the users. As shown in FIG. 9, the users may pull the cap 50 to disengage or to remove the housing 20 from the tool handle 11.

Accordingly, the tool handle in accordance with the present invention includes a radio engaged therein, for allowing the users to enjoy the radio programs or music while working or while using the tool handle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool comprising:
a handle including a chamber formed therein, and
a radio facility received in said chamber of said handle, for communicating with radio stations while using said handle.

2. The tool as claimed in claim 1, wherein said radio facility includes a housing, and includes a radio device having a circuit board disposed within said housing and having a plurality of electric elements disposed thereon, and a volume adjusting knob and at least one button coupled to said electric elements of said circuit board, and at least one battery disposed within said housing for energizing said electric elements of said circuit board, and a speaker coupled to said electric elements of said circuit board, for generating sounds.

3. The tool as claimed in claim 2, wherein said circuit board includes an antenna electrically coupled thereto, for facilitating signal receiving function to said radio device.

4. The tool as claimed in claim 3, wherein said handle includes a driving tool member attached thereto, said antenna is electrically coupled to said driving tool member.

5. The tool as claimed in claim 4, wherein said radio device includes a conductor member coupled between said antenna and said driving tool member.

6. The tool as claimed in claim 2, wherein said handle includes at least one projection extended into said chamber thereof, said housing includes at least one perforation formed therein, for receiving said at least one projection of said handle, and for anchoring said housing to said handle.

7. The tool as claimed in claim 2, wherein said housing includes a cover attached thereto, and having at least one spring blade formed therein and aligned with said at least one button of said circuit board, for actuating said at least one button when said at least one spring blade of said cover is depressed.

8. The tool as claimed in claim 7, wherein said cover includes a leg extended from said at least one spring blade, for engaging with said button of said circuit board.

9. The tool as claimed in claim 7, wherein said cover includes a peripheral slot formed therein, for forming said at least one spring blade therein.

10. The tool as claimed in claim 7, wherein said cover includes a notch formed therein and defined by a base panel which includes said at least one spring blade provided therein.

11. The tool as claimed in claim 10, wherein said cover includes a cap pivotally attached to said cover with a pivot axle, to allow said cap to be rotated relative to said cover, and to selectively enclose said notch of said cover, said cap includes a latch provided thereon for engaging with said cover and for selectively latching and locking said cap to said cover; and includes a plurality of apertures formed therein.
